(19) United States
(12) Patent Application Publication
(10) Pub. No.: US 2024/0218984 A1
(43) Pub. Date: Jul. 4, 2024

(54) PRESSURE CONTROL DEVICE

(71) Applicant: Zero Emission Industries, Inc., Alameda, CA (US)

(72) Inventors: Joseph Pratt, Fremont, CA (US); Daniel Terlip, Wheat Ridge, CO (US); John M. Motlow, San Francisco, CA (US)

(21) Appl. No.: 18/557,680

(22) PCT Filed: Apr. 27, 2022
(86) PCT No.: PCT/US2022/071944

§ 371 Date: Oct. 27, 2023

Related U.S. Application Data
(60) Provisional application No. 63/180,135, filed on Apr. 27, 2021.

(51) Int. Cl. F17C 13/12; F17C 13/04

(52) U.S. Cl. CPC F17C 13/123; F17C 13/04; F17C 2201/0119; F17C 2205/0326; F17C 2205/0332; F17C 2205/0394; F17C 2221/012; F17C 2221/014; F17C 2221/016; F17C 2221/033; F17C 2223/036; F17C 2250/0439

(57) ABSTRACT

A pressure control device including a valve with a fluid inlet and a fluid outlet, wherein the fluid inlet is in selective fluid communication with the fluid outlet. A heat collector is adapted to cover portion of an envelope of a pressure vessel and operative to receive heat from a heat source. A sensing element is in thermal communication with the heat collector and operative to receive the heat from the heat source. Operative to receiving heat from the sensing element receives the heat, the sensing element actuates the valve to establish the selective fluid communication between the fluid inlet and the fluid outlet.

### CROSS-REFERENCE TO RELATED APPLICATIONS

The present application claims priority to U.S. Patent Application No. 63/180,135 filed Apr. 27, 2021 and entitled “Pressure Control Device,” the entirety of which is incorporated herein by reference for all purposes.

### FIELD

The present disclosure relates generally to pressure control devices, particularly pressure control devices that protect a pressure vessel from exposure to a heat source.

### BACKGROUND

Gases are often stored in pressurized vessels. Such gases can include inert gases such as nitrogen argon, flammable gases such as methane or hydrogen, and reactive gases such as chlorine. The pressure ratings of pressure vessels can vary based on the application. In some examples, the pressure rating of a vessel may be 250-bar, 350-bar, 700-bar, or higher. When a gas is heated, the pressure increases due to the well-known Charles' law. If a gas stored in a pressure vessel is heated too much, such as when the pressure vessel is subjected to a heat source such as a fire, the pressure can rise above the pressure rating of the vessel possibly leading to a rupture and subsequent larger fire, explosion, chemical exposure, and resulting injury and/or property damage.

Traditional approaches to relieving excess pressure include using a pressure relief device in communication with the internal compartment of the pressure vessel and a vent. Some pressure relief devices relieve pressure from the vessel to the vent by sensing an excess pressure and venting gas to control the pressure in the vessel. Some pressure relief devices, often called temperature-pressure relief devices (TPRDs) sense temperature and vent gas when the temperature is excessive, to control pressure in the vessel. Excessive gas temperature may be caused by gas heating such as when a pressure vessel is subjected to an engulfing fire (e.g., a fire caused by a spill of a flammable liquid that spreads out beneath the pressure vessel and surrounds some or all of the vessel with fire). However, there are fire scenarios other than an engulfing fire that may lead to relatively little internal gas heating yet may still compromise the structural integrity of the pressure vessel. For example, a jet or point fire may be caused by a leak of a flammable gas or liquid from a ruptured, damaged, or leaking conduit. The point fire may be directed at a small portion of a pressure vessel and cause local damage to the pressure vessel while not causing substantial heating to the fluid contained in the vessel. In such situations, traditional approaches to relieving excess pressure of a pressurized fluid may be inadequate by failing to detect the local fire and may allow a pressure vessel to rupture. Such traditional TPRDs sense temperature at a single point or along a single line with respect to the vessel. Traditional TPRDs may thus fail to protect a vessel even as a heat source such as a localized fire damages the vessel, possibly leading to a rupture and/or explosion.

FIG. 1A shows a pressure vessel 104 with a pressure control device 106 of the prior art. The pressure vessel 104 has an envelope 114 defined by walls and ends, wherein the envelope 114 surrounds a fluid tight internal compartment 116 suitable to contain a pressurized fluid, such as a gas or liquid. The pressure control device 106 includes a sensing element 108 adapted to sense heat at a point within the body of the pressure control device 106. As shown in FIG. 1A, the pressure vessel 104 may be subjected to a heat source 102 that is remote from, or not in contact with, the sensing element 108. For example, Hydrogen fires may be localized and narrow in area affected. Thus, they may impinge on and damage the envelope 114 of the pressure vessel without causing a sufficient increase in temperature in the fluid in the vessel to trigger a prior art relief device. Thus, such devices may be ineffective to protect pressure vessels against hydrogen fires and/or other localized heat sources. FIG. 1B shows a typical heat flow for the device of FIG. 1A subjected to a localized heat source such as a point fire. The heat source 102 emits heat (represented by the arrows between boxes of FIG. 1B). Before the heat is detected by the sensing element 108, the heat must travel through the envelope 114, through the fluid 118 in the vessel, and then to the sensing element 108. By the time the sensing element 108 registers an excessive temperature, the envelope 114 may have been structurally compromised by the heat source and may lead to a vessel rupture or explosion. Thus, the pressure control device 106 may not adequately protect the pressure vessel 104 from excessive temperatures and/or structural failure.

FIG. 2A shows a pressure vessel 104 with a pressure control device 110 of the prior art. The pressure control device 110 improves over the pressure control device 106 by sensing excessive temperatures at a line along a linear sensing element 112. While the pressure control device 110 improves upon the technology of the pressure control device 106, the pressure control device 110 still insufficiently protects the pressure vessel 104 as the pressure vessel 104 may be subjected to a heat source 102 at a location away from the sensing element 112. For example, FIG. 2B, shows a typical heat flow for the device of FIG. 2A subjected to a localized heat source such as a point fire. The heat source 102 emits heat (represented by the arrows between boxes of FIG. 2B). While some heat may be transmitted directly to the sensing element 112, the limited coverage of the envelope by the linear sensing element 112 makes it much more likely that a localized heat source 102 will be directed to the envelope 114 rather than the sensing element 112. As with the prior art device of FIG. 1A, before the heat is detected by the sensing element 108, the heat must travel through the envelope 114, through the fluid 118 in the vessel, and then to the sensing element 108. By the time the sensing element 108 registers an excessive temperature, the envelope 114 may have been structurally compromised by the heat source and may lead to a vessel rupture or explosion. Thus, the pressure control device 110 may not adequately protect the pressure vessel 104 from excessive temperatures and/or structural failure.

A solution is desired that can better detect excessive temperatures to which a pressure vessel may be subjected, and safely vent a fluid to reduce pressure in the vessel.

### BRIEF SUMMARY

In some embodiments a pressure control device is disclosed, including a valve including a fluid inlet and a fluid outlet, where the fluid inlet is in fluid communication with an internal compartment of a pressure vessel and is in selective fluid communication with the fluid outlet; and a sensing element operative to detect at heat from a heat source, wherein when the sensing element detects the heat, the sensing element actuates the valve to establish the selective fluid communication between the fluid inlet and the fluid outlet.

Optionally, in some embodiments, the pressure control device includes a heat collector adapted to enclose a substantial portion of an envelope of the pressure vessel and operative to receive the heat from the heat source, wherein the sensing element is in thermal communication with the heat collector.

Optionally, in some embodiments, the heat collector includes a heat conduit operative to direct the heat from the heat source to the sensing element.

Optionally, in some embodiments, the heat conduit contains a heat transfer fluid that vaporizes to form a vapor responsive to exposure to the heat source. The vapor carries the heat to an end of the heat conduit proximate to the sensing element.

Optionally, in some embodiments, a dimension of the sensing element decreases responsive to exposure to the heat source.

Optionally, in some embodiments, the valve includes, a body forming an inlet chamber in fluid communication with the fluid inlet, and an outlet chamber in fluid communication with the fluid outlet; a seat disposed between the inlet chamber and the outlet chamber including an aperture in fluid communication with the inlet chamber and the outlet chamber; and a poppet operative to selectively close the aperture to sever the fluid communication between the inlet chamber and the outlet chamber, wherein the poppet is operatively coupled to the sensing element.

Optionally, in some embodiments, the pressure control device includes a biasing element operative to bias the poppet to close the aperture.

Optionally, in some embodiments, the sensing element overcomes the bias of the biasing element responsive to exposure of the sensing element to the heat source.

Optionally, in some embodiments, the sensing element has a negative coefficient of thermal expansion.

Optionally, in some embodiments, the sensing element includes a shape memory alloy.

Optionally, in some embodiments, the sensing element comprises two or more sensing elements coupled to a connector.

Optionally, in some embodiments, the connector is coupled to the two or more sensing elements; and the pressure control device includes a link coupled to the connector and coupled to the poppet.

Optionally, in some embodiments, a dimension of the sensing element increases responsive to exposure to the heat source.

Optionally, in some embodiments, the sensing element includes two or more sensing elements coupled to a connector.

Optionally, in some embodiments, the connector is coupled to the two or more sensing elements; and the pressure control device further includes a link coupled to the connector and coupled to the poppet.

Optionally, in some embodiments, the sensing element has a positive coefficient of thermal expansion.

Optionally, in some embodiments, the sensing element generates an electric current responsive to exposure to the heat source, and the electric current is operative to actuate the valve.

Optionally, in some embodiments, the sensing element comprises two or more dissimilar electrical conductors in electrical communication with one another to form a thermo-voltaic junction.

Optionally, in some embodiments, the sensing element is breakable responsive to exposure to the heat source.

Optionally, in some embodiments, the sensing element is burnable responsive to exposure to the heat source.

Optionally, in some embodiments, the pressure control device includes a power supply in electrical communication with an electrical conduit of the sensing element; a controller in electrical communication with the power supply and the sensing element, wherein the power supply and the electrical conduit form an electrical circuit and the controller is operative to detect an absence of the electrical current in the electrical conduit responsive to the breakage of the sensing element.

Optionally, in some embodiments, the sensing element gradually actuates the valve.

Optionally, in some embodiments, the sensing element comprises a first sensing element and a second sensing element, wherein the first sensing element has a first coefficient of thermal expansion and the second sensing element has a second coefficient of thermal expansion different than the first coefficient of thermal expansion.

Optionally, in some embodiments, the first and second coefficients of thermal expansion are negative.

Optionally, in some embodiments, the second coefficient of thermal expansion is more negative than the first coefficient of thermal expansion.

Optionally, in some embodiments, the first and second coefficients of thermal expansion are positive.

Optionally, in some embodiments, the second coefficient of thermal expansion is more positive than the first coefficient of thermal expansion.

Optionally, in some embodiments, at least a portion of one of the sensing element or the heat collector is integrally formed with the envelope of the pressure vessel.

Optionally, in some embodiments, the pressure vessel envelope includes a composite material and at least one of the sensing element or the heat collector is woven with the composite material.

Optionally, in some embodiments, the heat collector forms at least a portion of an outer layer of the envelope.

In some embodiments, a pressure control device is disclosed including a valve including a body having a fluid inlet and a fluid outlet formed therein and in fluid communication with one another, a poppet disposed between and operative to selectively prevent a flow of fluid between the fluid inlet and the fluid outlet, and an intermediate element selectively engaged with the poppet to selectively fix the poppet in a closed position; and a sensing element coupled to the intermediate element and operative to detect heat from a heat source, wherein when the sensing element detects the heat, the sensing element disengages the intermediate element from the poppet to enable the poppet to move from the closed position to an open position and selectively allow the flow of fluid between the fluid inlet and the fluid outlet.

Optionally, in some embodiments, the pressure control device includes a biasing element that biases the poppet toward the closed position.

Optionally, in some embodiments, the pressure control device includes heat collector adapted to enclose a substantial portion of an envelope of a pressure vessel and operative to receive heat from the heat source, wherein the sensing element is in thermal communication with the heat collector.

Optionally, in some embodiments, the pressure control device is not automatically resettable.

In some embodiments, a pressure control device includes a valve including: a body having a fluid inlet and a fluid outlet formed therein and in fluid communication with one another, a channel formed in the body between the fluid inlet and the fluid outlet, a poppet disposed in the channel between and operative to selectively prevent a flow of fluid between the fluid inlet and the fluid outlet, and a first portion of a working fluid received in a portion of the channel and operative to selectively fix the poppet in a closed position; and a sensing element that contains a second portion of the working fluid. The first portion of the working fluid is in fluidic communication with the second portion of the working fluid, when the sensing element detects heat from a heat source, the second portion of the working fluid experiences a phase change such that the poppet moves from a closed position to an open position and selectively allows the flow of the fluid between the fluid inlet and the fluid outlet.

Optionally, in some embodiments, the sensing element ruptures responsive to receiving the heat.

Optionally, in some embodiments, the sensing element comprises an annular jacket that at least partially surrounds a pressure vessel containing the fluid.

Optionally, in some embodiments, the sensing element melts responsive to receiving the heat, and ruptures responsive to the melting.

In some embodiments, a pressure control device includes a valve including: a body having a fluid inlet and a fluid outlet formed therein and in fluid communication with one another, and a poppet disposed between and operative to selectively prevent a flow of fluid between the fluid inlet and the fluid outlet when in a closed position; a sensing element including: a cylinder having a closed portion and an open portion, a piston slidably received in the cylinder between the closed portion and the open portion and mechanically coupled to the poppet by a linkage, and a working fluid contained in the closed portion of the cylinder and operative to apply a tension to the linkage suitable to releasably fix the poppet in a closed configuration. When the sensing element ruptures responsive to receiving heat from a heat source, such that the working fluid escapes from the closed portion enabling the poppet to move from the closed position to an open position.

### BRIEF DESCRIPTION OF THE SEVERAL VIEWS OF THE DRAWINGS

FIG. 1A illustrates an embodiment of a first prior art pressure control device.

FIG. 1B is a schematic diagram showing a typical heat flow with the prior art device of FIG. 1A.

FIG. 2A illustrates an embodiment of a second prior art pressure control device.

FIG. 2B is a schematic diagram showing a typical heat flow with the prior art device of FIG. 2A.

FIG. 3A illustrates an embodiment of a pressure control device including a valve and a heat sensor.

FIG. 3B illustrates an embodiment of a pressure control device with an embodiment of a heat sensor and the valve of FIG. 3A.

FIG. 3C is a partial section view of the heat sensor of FIG. 3B taken along section line 3C-3C of FIG. 3B including a heat conduit.

FIG. 3D is a partial section view of the heat sensor of FIG. 3B taken along section line 3C-3C of FIG. 3B including an alternative heat conduit.

FIG. 3E illustrates a schematic view of the valve of the pressure control device of FIG. 3A in a first configuration.

FIG. 3F illustrates a schematic view of the valve of the pressure control device of FIG. 3A in a second configuration.

FIG. 3G illustrates a pressure vessel including the pressure control device of FIG. 3A.

FIG. 4A illustrates an embodiment of a pressure control device including the valve of FIG. 3A and a heat sensor.

FIG. 4B illustrates a pressure vessel including the pressure control device of FIG. 4A.

FIG. 5A illustrates an embodiment of a heat sensor.

FIG. 5B illustrates a pressure vessel including a pressure control device with the heat sensor of FIG. 5A.

FIG. 5C illustrates an alternate embodiment of a heat sensor.

FIG. 5D illustrates a pressure vessel including a pressure control device with the heat sensor of FIG. 5C.

FIG. 6A illustrates an embodiment of a pressure control device including a valve and a heat sensor.

FIG. 6B illustrates a schematic view of the valve of the pressure control device of FIG. 6A in a first configuration.

FIG. 6C illustrates a schematic view of the valve of the pressure control device of FIG. 6A in a second configuration.

FIG. 6D illustrates an embodiment of a pressure control device including the valve of FIG. 6A and a heat sensor.

FIG. 7 illustrates an example of a controller suitable for use with a pressure control device.

FIG. 8 is a schematic diagram showing a typical heat flow with the devices of the present disclosure.

FIG. 9A illustrates a simplified schematic view of an embodiment of a pressure control device in a closed configuration.

FIG. 9B illustrates the pressure control device of FIG. 9A in an open configuration.

FIG. 10A illustrates a simplified schematic view of an embodiment of a pressure control device in a closed configuration.

FIG. 10B illustrates the pressure control device of FIG. 10A in an open configuration.

FIG. 11A illustrates a simplified schematic view of an embodiment of a pressure control device in a closed configuration.

FIG. 11B illustrates the pressure control device of FIG. 11A in an open configuration.

### DETAILED DESCRIPTION

Disclosed herein are devices and methods of controlling the pressure in a pressure vessel subjected to an external heat source such as a fire. In many embodiments, the pressure control devices disclosed herein, include a heat sensor and a valve. Heat sensors disclosed herein are adapted to sense heat around the envelope of a pressure vessel to better protect vessels relative to pressure control devices of the prior art. In some embodiments, a large surface area heat collector is placed around a pressure vessel, such as to protect the pressure vessel from heat sources, such as engulfing fires and narrow fires. The pressure control devices thermally detect a heat source by exhibiting a physical, chemical, or electrical response. For example, various pressure control devices disclosed herein may change shape, electrical characteristics, and/or deteriorate in response to exposure to a heat source. The response is suitable to open an appropriate valve to vent pressure from the pressure vessel (e.g., to a vent stack). The pressure control devices can be formed in a variety of shapes and dimensions and/or can be implemented as a conformable wrap to the pressure vessel itself. The pressure control devices may incorporate electronic sensing to trigger a notification system or actuate valves or other safety systems. Pressure control devices of the current disclosure may eliminate the need for other detection systems, frequent inspection of piping, welded piping and other safety systems needed to prevent or mitigate the occurrence of damage due to heat sources, such as hydrogen fires.

The pressure control devices disclosed herein have many benefits relative to existing pressure control devices. For example, pressure control devices of the present disclosure can detect and mitigate the results from a point of jet fire before such a fire can compromise the integrity of a pressure vessel. For example a heat collector that covers a portion, including a substantial portion, of the pressure vessel can intercept and detect heat from a point heat source that may go un-detected with existing pressure control devices. The pressure control devices of the present disclosure can even be built into or integrated with the envelope of the pressure vessel such that substantially the entire envelope of the pressure vessel is protected from heat sources.

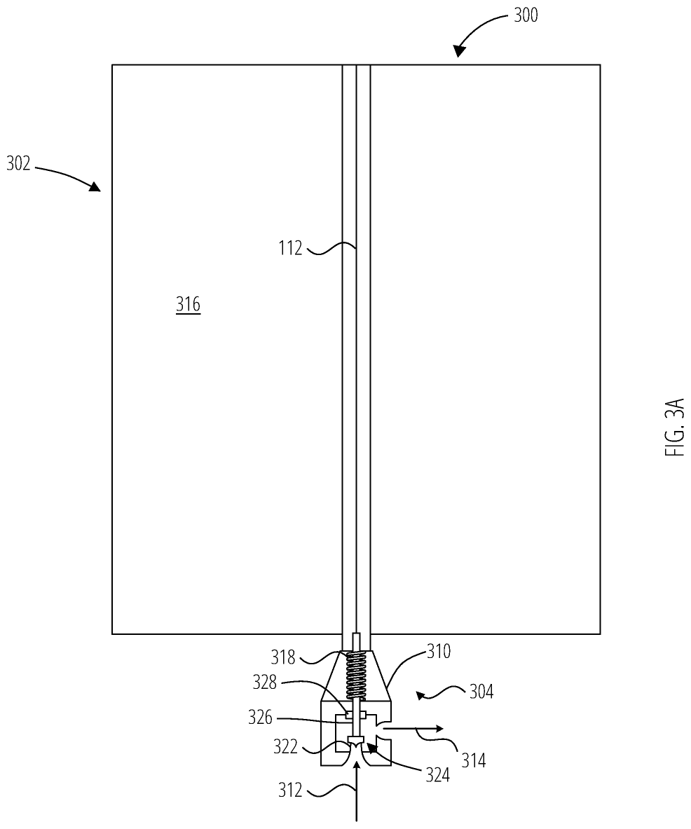

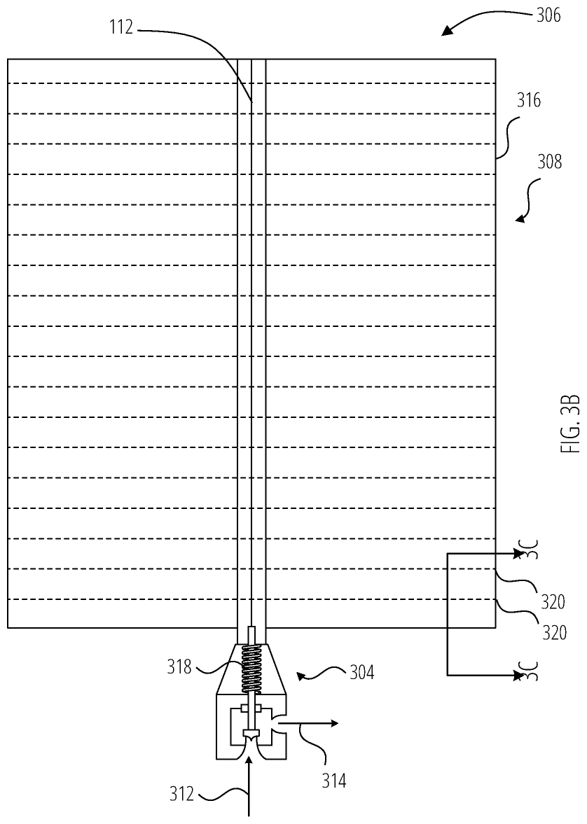

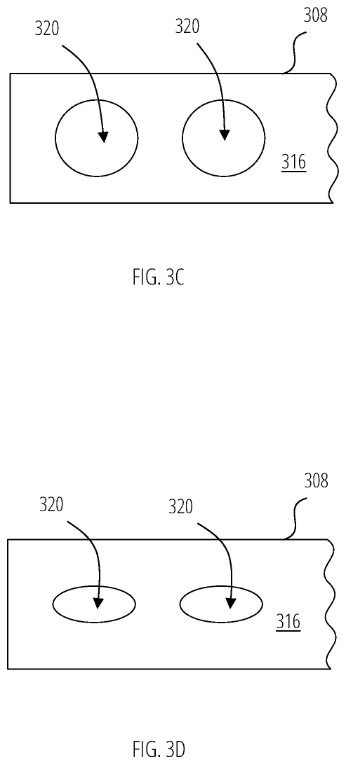

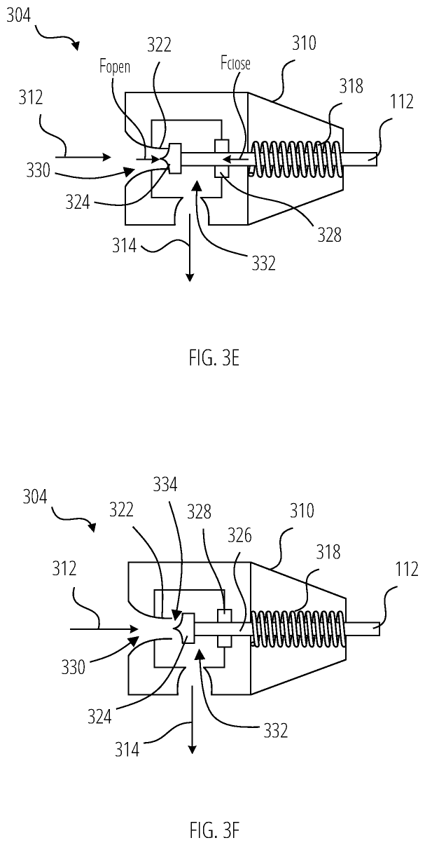

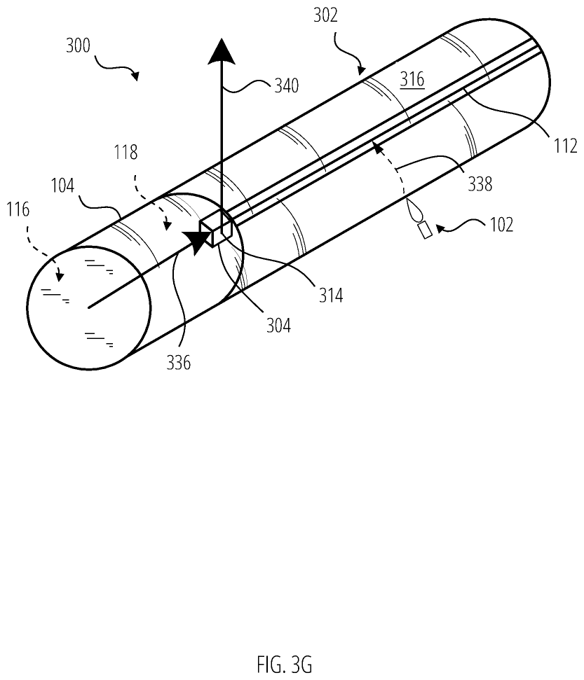

FIG. 3A illustrates an embodiment of a pressure control device 300 suitable for use to protect a pressure vessel 104 from excessive pressure caused by an external heat source 102. The pressure control device 300 includes a heat sensor 302 and a valve 304. The heat sensor 302 includes a heat collector 316 in thermal communication with a sensing element 112. In some embodiments, the heat sensor can be directly or indirectly coupled to the fluid control portions of the valve (e.g., a valve seat and/or poppet).

The sensing element 112 may be any element that generates a varied output (e.g., a physical or electrical change) in response to the application of heat. For example, in some embodiments, the sensing element 112 decreases in one or more dimensions when heated. For example, the sensing element 112 may have a negative coefficient of thermal expansion (CTE) where increased temperature causes a reduction of dimension. For example, the sensing element 112 may include a shape memory alloy such as a titanium or nickel-titanium alloy as described for example in U.S. Pat. No. 9,097,358 titled “Valve with temperature activated trigger having novel material configuration,” which is incorporated herein by reference in its entirety. The sensing element 112 may include other suitable materials with a negative CTE such as zirconium tungstate (ZrW₂O₈), a member of the AM₂Oₓ family of materials such as HfV₂O₇ and ZrV₂O₇, HfV₂O₇, ZrV₂O₇, and/or A₂(MO₄)₃ (where A=zirconium or hafnium and M=molybdenum, vanadium, or tungsten). The sensing element 112 may include carbon fibers which may exhibit a negative CTE between about 20° C. and 500° C.

The heat collector 316 may have a planar shape, such as a thin plate or sheet. In some embodiments, the heat collector 316 or sensing element 112 may have a spiral form that wraps around at least a portion of the envelope of a pressure vessel, such as external to the envelope or as a layer of the envelope. In some embodiments, a sensing element may be at least partially enclosed in a protection structure such as a tube to protect the sensing element from damage. The heat collector 316 may have a high thermal conductivity suitable to absorb heat from a heat source 102 and move (e.g., conduct, convect, and/or radiate) that heat to the sensing element 112. The heat collector 316 may surround or enclose a portion, including a substantial portion, of an envelope 114 of a pressure vessel 104. In some implementations, an insulating material may be disposed between the heat collector 316 and the pressure vessel 104. Such an insulting material may have the benefit of protecting the pressure vessel 104 from damage related to elevated temperatures, and may help further concentrate heat in the heat collector to increase the sensitivity of the sensing element 112. For example, the heat collector 316 may surround 10%, 20%, 30%, 40%, 50%, 60%, 70%, 80%, 90% or more of an envelope 114 of a pressure vessel 104. The heat collector 316 may be formable about a pressure vessel 104 (as shown, e.g., in FIG. 3G). For example, the planar shape may be formed into a substantially cylindrical shape to cover and/or conform to the envelope 114 of a cylindrical pressure vessel 104. For example, the heat collector 316 may be bent, rolled, cast, forged, stamped, or otherwise formed into a shape that substantially surrounds the envelope 114 of the pressure vessel 104. For example, the heat collector 316 may be made of a metal such as aluminum, steel (including stainless steel), brass, bronze, magnesium, or alloys of these and other metals which are readily formable into shapes to conform to the shape of a pressure vessel 104. In many examples, the CTE of the sensing element 112 may be negative, while the CTE of the heat collector 316 may be positive (or less negative) relative to the CTE of the sensing element 112.

In some embodiments, a portion of the heat sensor may be integrally or unitarily formed with the envelope 114 of the pressure vessel 104. For example, the envelope 114 may be formed from a composite material such as a fiber-reinforced composite (e.g., carbon fiber, aramid, glass, etc.) in a matrix material (e.g., epoxy or a polymer such as polyphenylene sulfide (PPS), polyester, etc.) A portion of the heat sensor, such as the sensing element 112 and/or heat collector 316 may be formed with the composite material. In some examples, at least a portion of the sensing element 112 or the heat collector 316 may be integrally formed (e.g., woven or layered) with the composite material. For example, in an envelope 114 formed with a fiber composite, such as carbon fiber/PPS, some of the carbon fibers may be woven with thermally conductive fibers such as metal fibers that are effective at conducting heat from an external heat source to a sensing element 112 to protect the pressure vessel 104 as disclosed herein. For example, the thermally conductive fibers may be more thermally conductive than the other fibers of the composite material (e.g., glass, carbon, aramid) so as to conduct heat to the sensing element 112 and actuate the valve to protect the pressure vessel 104 before an external heat source damages the envelope 114. In some examples, heat collector 316 and/or the sensing element includes a continuous electrical wire woven throughout a fabric that forms a portion of the envelope (e.g., at a close spacing such as 1 cm). In such examples, where the sensing element and/or heat collector are integrally formed with the pressure vessel envelope, the sensing element and/or heat collector may be a conformable layer or material that wraps around at least a portion of a pressure vessel. In some examples, the heat collector 316 may form an outer layer of the envelope. For example, a metal fiber composite may be layered with a carbon or other composite material to form the outer layer of the envelope 114 where the metal fiber composite forms a heat collector 316 in thermal communication with the sensing element 112. In other examples, a sensing element 112 may be woven with the fibers of a fiber composite envelope 114. Such integral or unitary forming of a portion of the heat sensor with the pressure vessel 104 envelope 114 may provide a benefit of enhanced protection of the pressure vessel 104 from external heat sources, weight savings, and ease of manufacturing and installation.

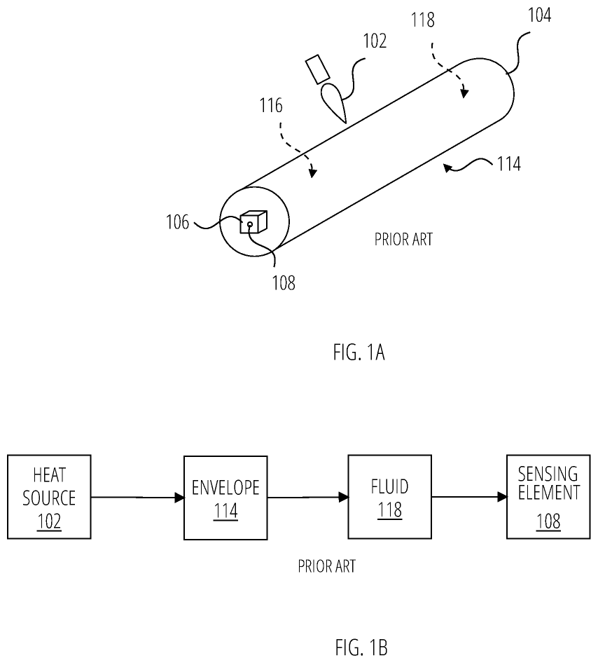

FIG. 3B illustrates an embodiment of a pressure control device 306 with a valve 304 as previously described coupled with another embodiment of a heat sensor 308. The heat sensor 308 includes a heat collector 316 as previously described. In this embodiment, the heat collector 316 includes one or more heat conduits 320. The heat conduits 320 may be disposed in the body of the heat collector 316 such as shown in FIG. 3C and FIG. 3D. The heat conduits 320 may include any material suitable to enhance the thermal conductivity of the heat collector 316 and/or assist in directing heat toward the sensing element 112. In some examples, a heat conduit 320 may be formed of an elongated piece of a material with a thermal conductivity greater than that of the heat collector 316. For example, the heat conduit 320 may be formed of a solid piece of copper disposed within a sheet of aluminum forming the heat collector 316. As copper has a higher thermal conductivity relative to aluminum, the heat conduits 320 may direct heat toward the sensing element 112 and may do so with less thermal resistance than a plain plate heat collector 316 such as described with respect to FIG. 1A. In some examples, the heat conduits 320 may be sealed hollow tubes that contain a heat transfer fluid. In other examples, a heat conduit 320 may include a vapor chamber, variable conductance heat pipe, pressure controlled heat pipe, diode heat pipe, thermosiphon, or the like. The heat conduits 320 may have suitable shapes such as circular (as shown in FIG. 3C) or oval (as shown in FIG. 3D) cross sections or other suitable cross sections such as rectangles, squares, triangles, other polygonal shapes, irregular shapes, or the like.

FIG. 3E shows an example of a valve 304 in a closed configuration. FIG. 3F shows the valve 304 in an open configuration. Other suitable types of valves may be used as desired. As shown in FIG. 3A and in further detail in FIG. 3E and FIG. 3F, the valve 304 includes a body 310 that defines an inlet chamber 330 and an outlet chamber 332. The inlet chamber 330 is in fluid communication with a fluid inlet 312. The outlet chamber 332 is in fluid communication with the fluid outlet 314. The body 310 may be fluid tight except for the fluid inlet 312 and the fluid outlet 314. The valve 304 may be adapted to control the flow of a fluid between the fluid inlet 312 and the fluid outlet 314. The fluid inlet 312 and the fluid outlet 314 may be adapted to fluidically connect to a conduit, pressure vessel, or other suitable components that can direct the flow of a fluid. The valve 304 may be in fluid communication with the internal compartment 116 of the pressure vessel 104 via a conduit or may be in fluid communication by direct coupling of the valve 304 to the pressure vessel 104. Any valve disclosed herein may be a discrete valve or may be components included in a larger assembly where the valve is integrated with other functions (e.g., composite overwrapped pressure vessel multi-function tank valve).

The body 310 includes a seat 322 between the inlet chamber 330 and the outlet chamber 332. The seat 322 defines an aperture 334 that is selectively closable by a poppet 324. When the poppet 324 is in the closed position. (e.g., as shown in FIG. 3E) the poppet 324 may prevent the flow of a fluid through the aperture 334 between the fluid inlet 312 and the fluid outlet 314. When the poppet 324 is not in the closed position (e.g., is partially open as shown in FIG. 3F or fully open), fluid may flow between the fluid inlet 312 and the fluid outlet 314.

The poppet 324 may be coupled to a shaft 326. The shaft 326 may be operatively coupled to the body 310 by a gland 328. For example, the gland may support the shaft 326 while allowing the shaft 326 to slide with respect to the gland 328. The gland 328 may seal a fluid within the outlet chamber 332 from escaping from the body around the shaft 326. The shaft 326 may be biased to a position, such as a closed position (e.g., as shown in FIG. 3E), by a biasing element 318 like a spring. The biasing element 318 may bias the poppet 324 and the shaft 326 to the closed position by overcoming a force (i.e., an opening force) induced by a pressure differential between the inlet chamber 330 and the outlet chamber 332. For example, an opening force may be represented by the equation Fₒₚₑₙ=AᵢₙₗₑₜPᵢₙₗₑₜ−AₒᵤₜₗₑₜPₒᵤₜₗₑₜ), where: Fₒₚₑₙ is the force tending to open the poppet; Aᵢₙₗₑₜ is the area of the poppet exposed to the inlet chamber Aₒᵤₜₗₑₜ is the area of the poppet exposed to the outlet chamber; and Pᵢₙₗₑₜ and Pₒᵤₜₗₑₜ are the fluid pressures in the inlet and outlet chambers, respectively. The biasing element 318 may generate a closing force F_{close} that opposes the opening force Fₒₚₑₙ. For example, a closing force may be represented by the equation F_{close}=½kx², where: k is the spring constant of the biasing element 318; and x is the amount of compression of the biasing element from its relaxed state. Typically, the valve 304 will be configured such that F_{close}>Fₒₚₑₙ when the sensing element 112 is not exerting a force on the shaft 326, such as when exposed to normal ambient conditions.

The shaft 326 may be coupled to the sensing element 112, such that the sensing element 112 can move the shaft 326 and the poppet 324 between open and closed positions. For example, if the sensing element 112 shrinks (e.g., due to heating), the sensing element 112 may move the shaft 326 from the closed position toward an open position (e.g., between the position in FIG. 3E toward the position shown in FIG. 3F). For example, a force induced by the shrinking of the sensing element 112 may overcome the forces tending to close the poppet 324. For example, the sensing element 112 may induce an activation force (F_{activation}) on the poppet 324. For example, the poppet 324 may open when Fₒₚₑₙ+F_{activation}≥F_{close}, allowing the valve to vent fluid in the pressure vessel.

FIG. 3G shows the pressure control device 300 installed about a pressure vessel 104, such as on a surface of the pressure vessel 104 or other suitable location outside the vessel 104. When the pressure control device 300 is installed on a pressure vessel 104, the heat collector 316 may at least partially cover the envelope 114 of the pressure vessel 104. The valve 304 is typically installed outside the vessel 104. For example, the valve may be installed on the envelope 114 of the vessel 104, or may be installed remotely from the vessel 104. When the heat collector 316 is subjected to a heat source 102, the heat source 102 may cause heat to be absorbed by the heat collector 316. The heat may move within the heat collector 316 by any suitable mode (e.g., conduction, convection, and/or radiation) such as shown by the heat flow 338. The heat flow 338 may reach the sensing element 112 via the heat collector 316. In examples with a heat conduit 320, the heat conduit 320 may enable the motion of the heat flow 338 toward the sensing element 112. In examples where the heat conduit 320 includes a heat transfer fluid, when the heat transfer fluid is exposed to a heat source 102, the fluid may vaporize, carrying heat along the heat conduit 320 in the form of a vapor. The vapor may reach an end of the heat conduit 320 proximate to the sensing element 112 and may condense to a liquid as heat is transferred to the sensing element 112.

As the sensing element 112 is heated, its temperature may increase. The heating may cause a physical or electrical response in the sensing element that ultimately causes the valve to open, venting the pressure vessel. As the temperature of the sensing element 112 increases, the length of the sensing element 112 may decrease, for example, due to its negative CTE. As the length of the sensing element 112 decreases, the sensing element 112 may cause the valve 304 to open, as discussed above. Pressurized fluid in the pressure vessel 104 may flow from the pressure vessel 104 (e.g., through the conduit 336) to the valve 304 and to a vent 340. Thus, the pressure control device 300 may protect a pressure vessel 104 from thermally-caused over-pressure and/or structural failure due to the application of the external heat source 102 at substantially any location around the envelope 114 of the pressure vessel 104.

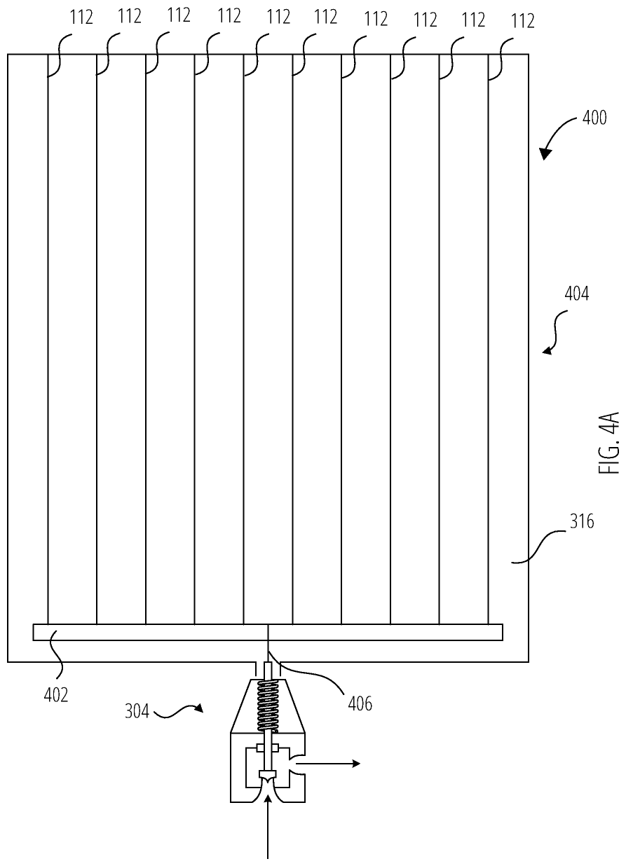

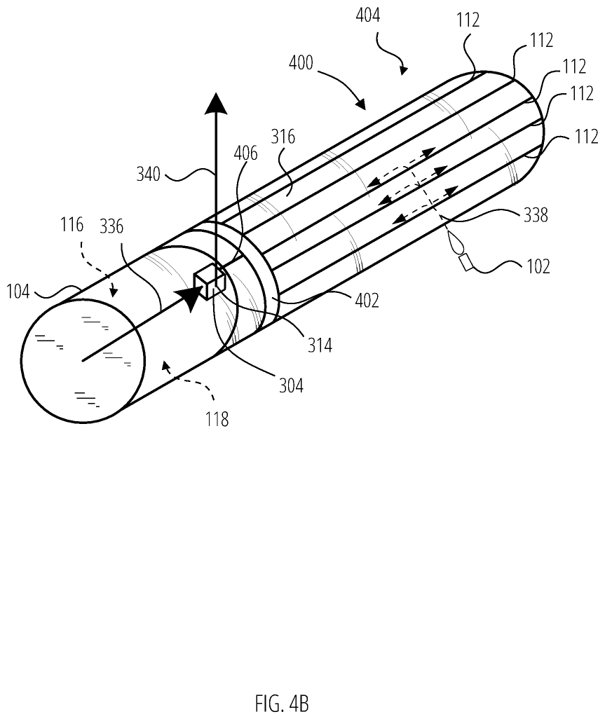

FIG. 4A shows an embodiment of a pressure control device 400 with a valve such as the valve 304 and a heat sensor 404. The heat sensor 404 includes two or more sensing elements 112 which may be formed of a material with a negative CTE, as discussed herein. The sensing elements 112 may be mechanically coupled by a connector 402, such as a plate, cable, bar, or the like. The valve 304 is typically installed outside the vessel 104. For example, the valve may be installed on the envelope 114 of the vessel 104, or may be installed remotely from the vessel 104. The connector 402 may combine or amplify the forces induced by the two or more sensing elements 112 as the sensing elements 112 shrink, e.g., from heating. The connector 402 may be coupled to the shaft 326 of the valve 304 by a link 406. The link 406 may be a shaft, cable, plate, or the like. FIG. 4B shows the pressure control device 400 installed about a pressure vessel 104. As shown, the heat from a heat source 102 may be directed along the heat collector 316 to one or more of the sensing elements 112. In some embodiments, the valve may open substantially completely when a temperature threshold is reached. In some embodiments the valve may open proportionally in response to rising temperatures. For example, different sensing elements 112 may react differently to the same temperature. For example, some sensing elements 112 may have different CTEs. For example, a first sensing element 112 may have a CTE such that it shrinks appreciably (i.e., enough to cause at least some movement of the poppet) when heated to 100° ° C., while a second sensing element 112 shrinks appreciably when heated to a temperature of 200° C. Such an implementation of sensing elements with different temperature responses may allow a valve 304 to open gradually in response to rising temperatures. An advantage of gradual valve opening may be that the vent flow of fluid (particularly fluid under high pressure and/or a flammable fluid) in the vessel is controlled to reduce further risk of fire or equipment damage associated with rapid venting. In some embodiments, the sensing elements 112 may be disposed in a pattern where two or more sensing elements 112 are at a non-parallel angle relative to one another. For example, the sensing elements 112 may be disposed in a grid with some elements at an angle (e.g. 90 degrees) with respect to other elements 112. In some embodiments, the grid may include sensing elements 112 woven together, such as in a warp and weft pattern. Such a grid pattern may increase the sensitivity of the heat sensor 404. An advantage of the heat sensor 404 may be increased sensitivity to heat increases, better coverage of the envelope 114 of the pressure vessel 104, and/or increased actuation force to operate the valve 304 to better protect a pressure vessel 104 from thermally-caused over-pressure and/or structural failure such as caused by exposure to a heat source 102.

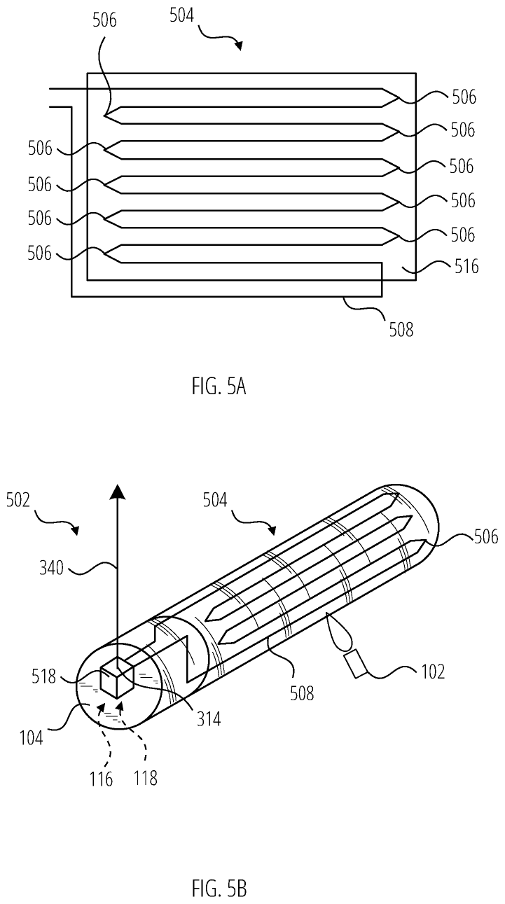

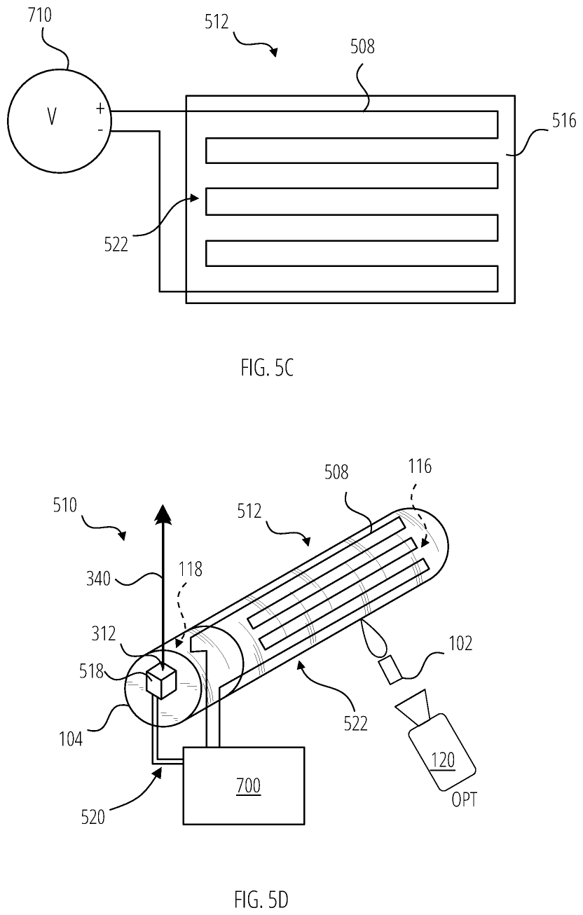

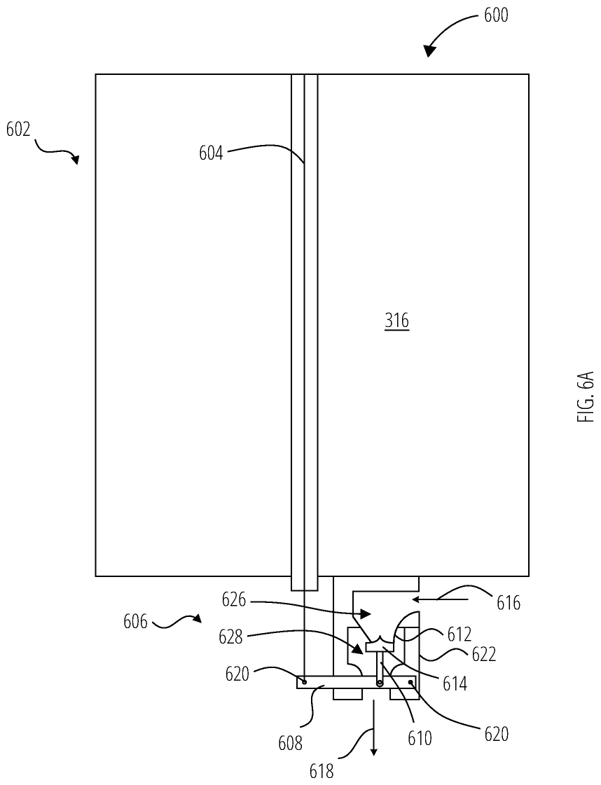

FIG. 5A shows an embodiment of a heat sensor 504 with a heat collector 516 including one or more thermo-voltaic junctions 506. As used herein, a thermo-voltaic junction 506 is any device that can generate an electrical potential and/or current when exposed to a heat flow. For example, a thermo-voltaic junction 506 may be a device that exhibits the thermoelectric effect. The thermoelectric effect occurs when two or more dissimilar electrical conductors are in electrical communication with one another. Some examples of a thermo-voltaic junction 506 include a thermocouple, a thermopile, and a thermo-electric generator (e.g., a generator that operates on the Seebeck effect). In some examples, a thermo-voltaic junction 506 may include a junction with one or more nickel alloys such as chromel (i.e., an alloy of nickel and chromium)-constantan (i.e., an alloy of copper and nickel), iron-constantan, chromel-alumel (e.g., an alloy of nickel, aluminum, manganese, and silicon), nicrosil (i.e., an alloy of nickel, chromium, silicon, and magnesium)-nisil (i.e., an alloy of nickel, silicon, and magnesium), copper-constantan, or the like. In some examples, a thermo-voltaic junction 506 may include a junction with one or more platinum-rhodium alloys, tungsten-rhenium alloys, chromel-gold-iron alloys, platinum-molybdenum allows, iridium-rhodium alloys, noble metal alloys, or the like. In some examples, a thermo-voltaic junction 506 may include a semiconductor junction. In the example shown in FIG. 5A, the thermo-voltaic junctions 506 are electrically in series with one another. In some examples, the thermo-voltaic junctions 506 may be electrically in parallel with one another. In some examples, the thermo-voltaic junctions 506 may be in any combination of electrically in parallel or series with one another. For example, the thermo-voltaic junctions 506 may be in electrical communication with one another via an electrical conduit 508, such as a wire, a conductor trace, a bus bar, or the like.

FIG. 5B shows an example of the pressure control device 502 installed with a pressure vessel 104. The electrical conduit 508 of the pressure control device 502 may be in electrical communication with a valve 518. The valve 518 may be in fluid communication with the internal compartment 116 of the pressure vessel 104, such as via a fluid inlet 312 and with a vent 340, such as via a fluid outlet 314 of the valve 518. The valve 518 may be in fluid communication with the internal compartment 116 of the pressure vessel 104 via a conduit or may be in fluid communication by direct coupling of the valve 518 to the pressure vessel 104. The valve 518 may be an electrically operated valve, such as a valve 518 that includes a solenoid, sensor, or other suitable device that causes the valve 518 to open to allow a fluid to pass from the fluid inlet 312 to the fluid outlet 314 responsive to receiving electrical power.

When the one or more thermo-voltaic junctions 506 of the pressure control device 502 are heated by a heat source 102, the thermo-voltaic junctions 506 may generate an electrical potential and/or current. The potential and/or current may travel along the electrical conduit 508 to the valve 518. The electrical current/potential may cause the valve 518 to open, allowing a fluid to pass from the fluid inlet 312 to the fluid outlet 314. For example, fluid in the internal compartment 116 of the pressure vessel 104 may pass to the vent 340 via the valve 518. Thus, when the pressure vessel 104 is subjected to a heat source 102, the controller 700 may open to protect the pressure vessel 104 from thermally-caused over-pressure and/or structural failure.

FIG. 5C shows an embodiment of a heat sensor 512 with a heat collector 516 including an electrical conduit 508. The electrical conduit 508 may be connected to a power supply 514, such as a voltage and/or current source. The electrical conduit 508 and the power supply 514 may form an electrical circuit 522. The power supply 514 may induce an electrical current in the electrical conduit 508. The power supply 514 and/or a separate sensor may detect the presence of the electrical current in the electrical conduit 508 when the conduit is intact. The power supply 514 and/or sensor may detect the absence of the electrical current when the conduit is broken. Additionally or alternately, the power supply 514, controller 700, and/or sensor may detect a change in an electrical characteristic of the heat sensor 512. For example, the resistance, capacitance, and or inductance of the heat sensor 512 may change (e.g., may increase or decrease) when exposed to a heat source. The electrical conduit 508 may be a wire, trace, or other conductor that may be damaged, modified, and/or severed when exposed to a heat source 102. For example, the electrical conduit 508 may include a carbon-based conductor (e.g., carbon fiber) that can both conduct electricity and is also combustible, such that when exposed to a heat source 102, like a fire, the electrical circuit formed by the power supply 514 and the electrical conduit 508 is broken. In another example, the electrical conduit 508 may include a conductor with a low melting point (e.g., a melting point below a temperature that may damage a pressure vessel 104) that melts when exposed to a heat source 102, thereby breaking the circuit. In some examples, the melting point of the electrical conduit 508 may be about 50° C. to about 200° ° C. For example, the electrical conduit 508 may include a fusible alloy such as Rose's metal (i.e., an alloy of bismuth, lead, and tin) with a melting point of about 98° C.; cerrosafe or Wood's metal (i.e., alloys of bismuth, lead, tin, and cadmium) with melting points of about 70° C.-74° C.; Field's metal (i.e., an alloy of bismuth, tin, and indium) with a melting point of about 62° ° C.; a tin-lead alloy; or the like. In some examples, the electrical conduit 508 may include a cutectic alloy.

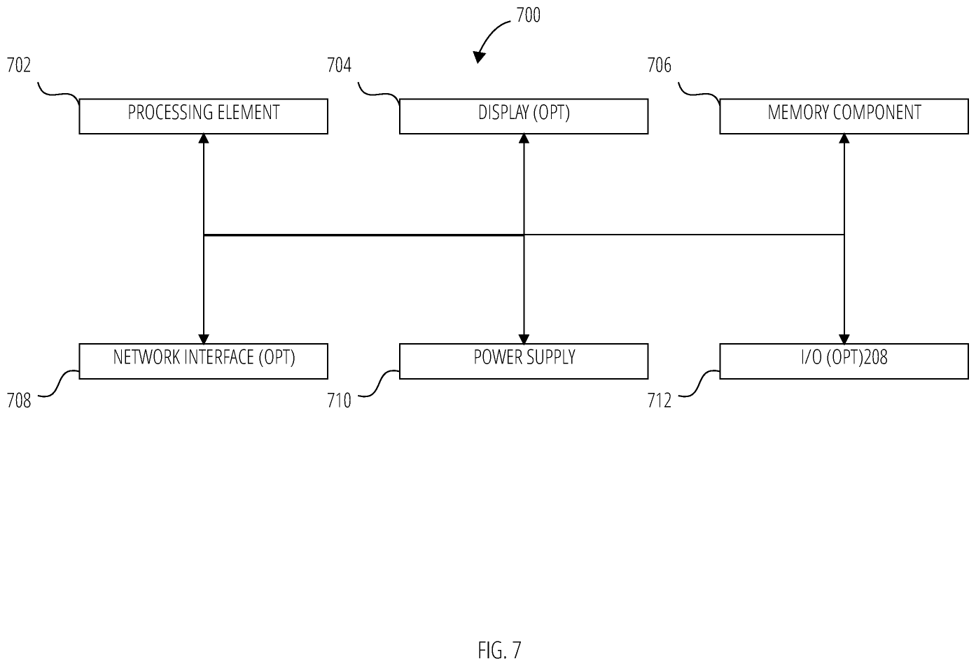

FIG. 5D shows an example of the pressure control device 510 installed with a pressure vessel 104. The electrical conduit 508 may be in electrical communication with the controller 700. The controller 700 may include a power supply 710 (see FIG. 7) that induces an electrical current and/or potential in the electrical conduit 508 forming a circuit 522. The controller 700 may detect the current and/or potential in the circuit 522. The controller 700 may have one or more electrical conduits 520 in electrical communication with the valve 518. When the electrical conduit 508 is exposed to a heat source 102, the electrical conduit 508 may burn or melt as described herein, thereby breaking the circuit 522. The controller 700 may detect the break in the circuit 522. When the controller 700 detects the break in the circuit 522, the controller 700 may supply electrical power via an electrical conduit 520 to open the valve 518.

An optional non-contact thermal sensor 120 may be provided. Some examples of the non-contact thermal sensor 120 include thermal camera, infrared or ultraviolet light detectors, or the like. The non-contact thermal sensor 120 may be adapted to detect elevated temperatures, light emissions, or other indications of a heat source 102. The non-contact thermal sensor 120 may be in electrical communication with the controller 700. The controller 700 may use a signal from the non-contact thermal sensor 120 to verify or confirm an indication from the sensing element, as previously described, that the pressure vessel 104 is being subjected to a heat source 102. In some embodiments, the controller 700 may open the valve 518 if both the sensing element 508 and the non-contact thermal sensor 120 indicate the presence of a heat source 102. In some embodiments, the controller 700 may open the valve 518 if the sensing element 508 or the non-contact thermal sensor 120 indicate the presence of a heat source 102, not requiring an indication from both.

In some embodiments, the valve 518 is a fail-open valve that receives electrical current from a power source via the sensing element 508, without the use of the controller 700. In some embodiments, the valve 518 can operate without the controller, but may be coupled to a controller (e.g., to receive an open/closed status signal from the valve). The electrical current may hold the valve in a closed position. In such an embodiment, if the sensing element 508 is damaged, modified, or broken, the electrical current to the valve 518 may be interrupted, causing the valve to open and vent the fluid in the vessel.

In some embodiments, the sensing element 508 may be thermally conductive and in thermal communication with a thermally-activated switch such as a bi-metallic switch. When the sensing element 508 receives heat from a heat source 102, the heat may be conveyed to the thermally-activated switch causing the switch to activate. When the thermally-activated switch activates, it may supply (or break a supply) of electrical current to the valve 518 causing the valve to open and vent the fluid in the vessel. In some embodiments, one or more thermally-activated elements (e.g., a bi-metallic element) may be disposed in the sensing element 508. The thermally activated elements may close an electrical circuit to supply electrical current to the valve 518 to cause the valve to open. Such embodiments may be advantageous to avoid false opening of the valve such as could be caused by a faulty power source.

The valve 518 may vent fluid from the pressure vessel 104 thereby protecting the pressure vessel 104 from thermally-induced overpressure and/or structural failure, as described above.

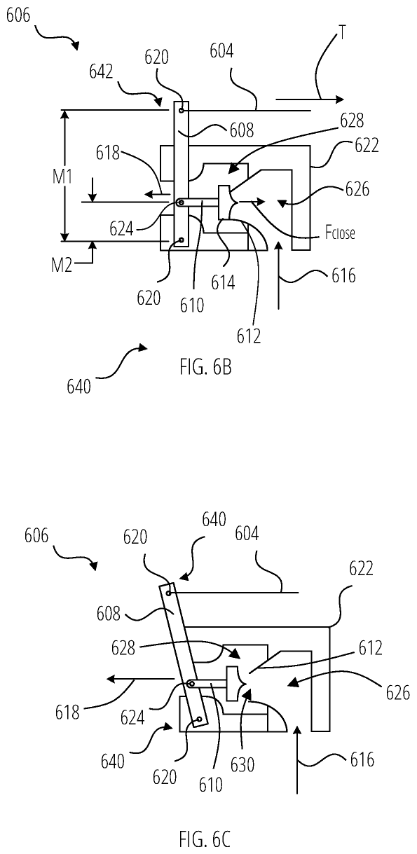

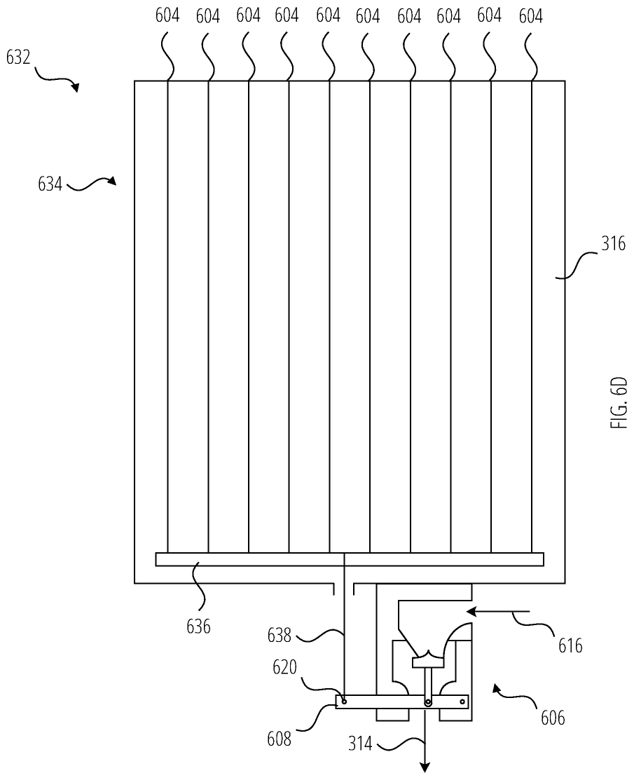

FIG. 6A shows a pressure control device 600 including a valve 606 and a heat sensor 602. The heat sensor 602 may include a heat collector 316 similar to the heat collector 316 described above. The heat sensor 602 may include a sensing element 604 with a positive CTE, such that when heated, the sensing element 604 expands or lengthens when heated to allow the valve 606 to open. In many examples, the CTE of the sensing element 604 may be greater than the CTE of the heat collector 316. Thus, when the sensing element 604 is heated, the sensing element 604 may lengthen. The lengthening of the sensing element 604 may cause the valve 606 to open. In some examples, the sensing element 604 may be an element that holds the valve 606 closed, but which may burn or break when heated to allow the valve 606 to open. For example, the sensing element 604 may be an elongated element made of a burnable material such as carbon fiber that may oxidize or burn when exposed to a heat source 102. In some examples, the sensing element 604 may be an elongated element formed with a low melting point alloy such as materials described with respect to the electrical conduit 508 (e.g., Rose's metal or the like) that may melt or relax and/or elongate when heated. In some embodiments, the valve may open substantially completely when a temperature threshold is reached. In some embodiments the valve may open proportionally in response to rising temperatures. In some embodiments, different sensing elements 112 may react differently to the same temperature. For example, some sensing elements 112 may have different CTEs. For example, a first sensing element 112 may have a CTE such that it expands appreciably (i.e., enough to cause at least some movement of the poppet) when heated to 100° ° C., while a second sensing element 112 expands appreciably when heated to a temperature of 200° C. Such an implementation of sensing elements with different temperature responses may allow a valve 304 to open gradually in response to rising temperatures. An advantage of gradual valve opening may be that the vent flow of fluid (particularly a fluid under high pressure and/or a flammable fluid) in the vessel is controlled to reduce further risk of fire or equipment damage associated with rapid venting.

FIG. 6B shows an example of a valve 606 in a closed configuration. FIG. 6C shows an example of the valve 606 in an open configuration. Other suitable types of valves may be used as desired. As shown in FIG. 6A and in further detail in FIG. 6B and FIG. 6C, the valve 606 includes a body 622 that defines an inlet chamber 626 and an outlet chamber 628. The inlet chamber 626 is in fluid communication with a fluid inlet 616. The outlet chamber 332 is in fluid communication with the fluid outlet 314. The body 622 may be fluid tight except for the fluid inlet 616 and the fluid outlet 618. The valve 606 may be adapted to control the flow of a fluid between the fluid inlet 616 and the fluid outlet 618. The fluid inlet 616 and the fluid outlet 618 may be adapted to fluidically connect to a conduit, pressure vessel 104, or other suitable components that can direct the flow of a fluid.

The body 622 includes a seat 612 between the inlet chamber 626 and the outlet chamber 628. The seat 612 includes an aperture 630 that is selectively closable by a poppet 614. When the poppet 614 is in the closed position. (e.g., as shown in FIG. 6B) the poppet 614 may prevent the flow of a fluid between the fluid inlet 616 and the fluid outlet 618 through the aperture 630. When the poppet 614 is not in the closed position as shown in FIG. 6C (e.g., is partially open or fully open), fluid may flow between the fluid inlet 616 and the fluid outlet 618.

The poppet 614 may be coupled to a shaft 610. The shaft 610 may be biased to a position, such as a closed position (e.g., as shown in FIG. 6B), such as by the sensing element 604 and/or a biasing element like a spring.

The valve 606 may include an arm 608. The arm 608 may include an elongated body with a first end 640 and a second end 642 opposite the first end 640. The arm 608 may be movable relative to the body 622, such as by a force imparted to the arm 608 by the sensing element 604, and/or by the pressure of a fluid on the inlet chamber 626 side of the poppet 614. The arm 608 may be coupled to the body 622, such as pivotally coupled at a joint 620. The shaft 610 may be coupled to the arm 608. For example, the shaft 610 may be pivotally coupled to the arm 608 via a joint 624. The arm 608 may be coupled to the sensing element 604. For example, the arm 608 may be coupled to the sensing element 604 at a joint 620. For example, the joint 620 may be a pivotable joint.

The sensing element 604 may bias the arm 608, the shaft 610, and/or the poppet 614 toward a closed position (e.g., as shown in FIG. 6B). For example, when the sensing element 604 is not heated by a heat source 102, the sensing element 604 may bias the valve 606 closed, such that the inlet chamber 626 and the outlet chamber 628 are not in fluid communication. For example, the sensing element 604 may bias the poppet 614 and the shaft 610 to the closed position by overcoming a force (i.e., an opening force) induced by a pressure differential between the inlet chamber 626 and the outlet chamber 628. For example, an opening force may be represented by the equation Fₒₚₑₙ=Aᵢₙₗₑₜ Pᵢₙₗₑₜ−Aₒᵤₜₗₑₜ Pₒᵤₜₗₑₜ), where: Fₒₚₑₙ is the force tending to open the poppet; Aᵢₙₗₑₜ is the area of the poppet exposed to the inlet chamber Aₒᵤₜₗₑₜ is the area of the poppet exposed to the outlet chamber; and Pᵢₙₗₑₜ and Pₒᵤₜₗₑₜ are the fluid pressures in the inlet and outlet chambers, respectively. The sensing element 604 may generate a closing force F_{close} that opposes the opening force Fₒₚₑₙ. For example, a closing force may be induced by a tension T in the sensing element set when the sensing element 604 is at normal thermal conditions (i.e., not exposed to a heat source 102). The closing force F_{close} may be enhanced by a moment arm. For example, the tension T may act on the arm a distance M₁ from the joint 620. The poppet may be disposed a distance M₂ from the pivot 620. M₂ may be less than M₁. When the closing force balances the tension, the sum of the moments about the joint 620 may be zero. Balancing the moments, the relationship between the tension T and the closing force may be described by F_{close}≥TM₁/M₂. Typically, the valve 304 will be configured such that F_{close}>Fₒₚₑₙ when the sensing element 112 is not exerting a force on the shaft 326, such as when exposed to normal ambient conditions. The sensing element 604 may impart a force or moment on the arm 608 that is greater than or equal to the moment or force imparted on the arm 608 by the pressure of the fluid in the inlet chamber 626, thus biasing the valve 606 closed. When the sensing element 604 is heated, such as when exposed to a heat source 102, the sensing element 604 may lengthen, weaken, and/or break. The lengthening, weakening, or breakage of the sensing element 604 may allow the force or moment imparted on the arm 608 by the fluid in the inlet chamber 626 to overcome the force or moment imparted on the arm 608 by the sensing element 604, the poppet 614 may move off the seat 612, and the valve 606 may open either partially (e.g., as shown in FIG. 6C) or fully. The inlet chamber 626 and the outlet chamber 628 may then be in fluid communication with one another, allowing fluid to pass from the fluid inlet 616 to the fluid outlet 618. The valve 606 may vent fluid from a pressure vessel 104 thereby protecting the pressure vessel 104 from thermally-induced overpressure and/or structural damage.

FIG. 6D shows an embodiment of a pressure control device 632 with a valve such as the valve 606 and a heat sensor 634. The heat sensor 634 includes two or more sensing elements 604 as described above. The sensing elements 604 may be mechanically coupled by a connector 636, such as a plate, cable, bar, or the like. The connector 636 may combine or amplify the forces induced by the two or more sensing elements 604. The connector 636 may be coupled to the arm 608. For example, the connector 636 may be coupled to the arm 608 by a link 638. The link 638 may be a shaft, cable, plate, or the like. The link 638 may couple to the arm 608 at a joint 620. An advantage of the heat sensor 634 may be increased sensitivity to heat increases, better coverage of the envelope 114 of the pressure vessel 104, and/or an increased force or moment to oppose a force or moment imparted to the arm 608 by fluid pressure in the inlet chamber 626 relative to a heat sensor with fewer sensing elements 604. Such balancing may enable the use of the valve 606 with higher pressure fluids than with a heat sensor with fewer sensing elements 604. Additionally, or alternately, having relatively more sensing elements 604 and/or the heat collector 316 in the heat sensor 634 may allow the use of a valve 606 with a relatively larger opening in the seat 612 to enable higher fluid flows. For example, the force or moment imparted by the fluid pressure in the inlet chamber 626 increases with the size of the aperture 630, as does a potential fluid flow through the aperture 630. Relatively more sensing elements 604 may be used to balance the size of the aperture 630 as the aperture 630 is increased in size, thereby enabling a valve 606 to more quickly vent a pressure vessel 104.

FIG. 7 illustrates a simplified block diagram for the various devices of the controller 700. As shown, the controller 700 may include one or more processing elements 702, an optional display 704, one or more memory components 706, a network interface 708, a power supply 710, and an optional input/output I/O interface 712, where the various components may be in direct or indirect communication with one another, such as via one or more system buses, contract traces, wiring, or via wireless mechanisms.

The one or more processing elements 702 may be substantially any electronic device capable of processing, receiving, and/or transmitting instructions. For example, the processing elements 702 may be a microprocessor, microcomputer, graphics processing unit, or the like. It also should be noted that the processing elements 702 may include one or more processing elements or modules that may or may not be in communication with one another. For example, a first processing element may control a first set of components of the computing device and a second processing element may control a second set of components of the computing device where the first and second processing elements may or may not be in communication with each other. Relatedly, the processing elements may be configured to execute one or more instructions in parallel locally, and/or across a network, such as through cloud computing resources.

The display 704 is optional and provides an input/output mechanism for devices of the controller 700, such as to display visual information (e.g., images, graphical user interfaces, videos, notifications, and the like) to a user, and in certain instances may also act to receive user input (e.g., via a touch screen or the like). The display may be an LCD screen, plasma screen, LED screen, an organic LED screen, or the like. The type and number of displays may vary with the type of devices (e.g., smartphone versus a desktop computer, versus a PLC).

The memory components 706 store electronic data that may be utilized by the controller 700, such as audio files, video files, document files, programming instructions, and the like. The memory components 706 may be, for example, non-volatile storage, a magnetic storage medium, optical storage medium, magneto-optical storage medium, read only memory, random access memory, erasable programmable memory, flash memory, or a combination of one or more types of memory components. The memory components optionally linked via a cloud network or the like via the network interface 708.

The network interface 708 receives and transmits data to and from a network to the various devices of the controller 700. The network interface 708 may transmit and send data to the devices of the controller 700 directly or indirectly. For example, the networking/communication interface may transmit data to and from other computing devices through a network such as a RS-232, DH-485, CANBUS, MODBUS, Ethernet, or other suitable network. In some embodiments, the network interface may also include various modules, such as an application program interface (API) that interfaces and translates requests across the network.

The controller 700 may include a power supply 710. The power supply 710 provides power to various components of controller 700 and optionally to other components of a pressure control device, such as a valve 518, a heat sensor 512, or the like. The power supply 514 may include one or more rechargeable, disposable, or hardwire sources, e.g., batteries, power cord, AC/DC inverter, DC/DC converter, fuel cell, or the like. Additionally, the power supply 710 may include one or more types of connectors or components that provide different types of power to the various devices of the controller 700 or pressure control devices. In some embodiments, the power supply 514 may include a connector (such as a universal serial bus) that provides power to the computer or batteries within the computer and also transmits data to and from the device to other devices.

The optional I/O interface 712 allows the controller 700 to receive input from a user and provide output to a user. For example, the I/O interface 712 may include a capacitive touch screen, keyboard, mouse, stylus, or the like. The type of devices that interact via the I/O interface 712 may be varied as desired.

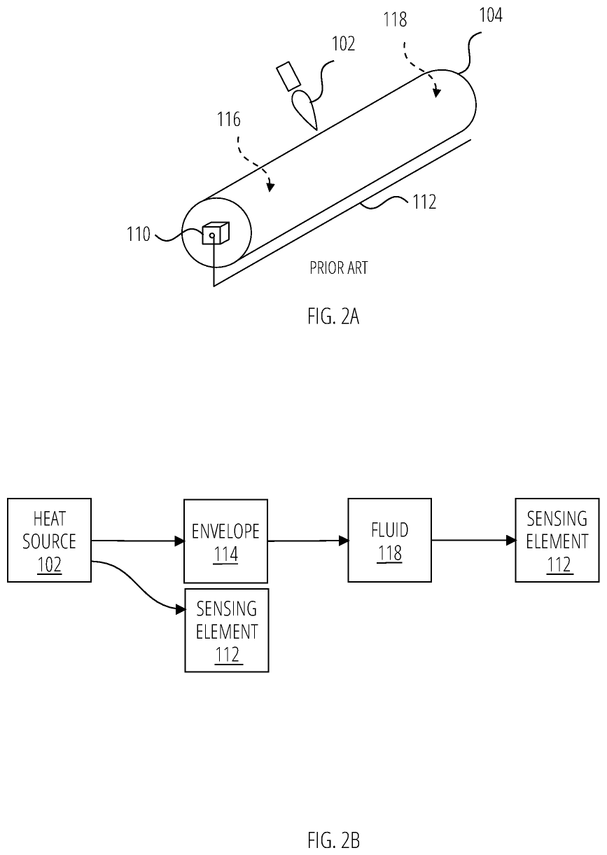

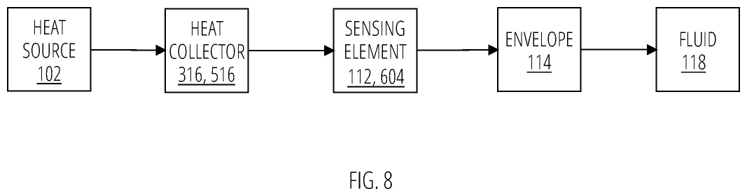

FIG. 8 is a schematic diagram showing a typical heat flow for any of the devices of the present disclosure when subjected to a localized heat source such as a point fire or an engulfing fire. The heat source 102 emits heat (represented by the arrows between boxes of FIG. 8). The heat is conveyed (by conduction, convection, and/or radiation) from the heat source 102 to the heat collector 316. A portion of the heat is conveyed to the sensing element. The sensing element may then activate the valve and vent the fluid from the vessel. Heat may continue to be conveyed from the sensing element to the envelope 114 and the fluid 118. However, in contrast to the devices of the prior art (e.g., FIGS. 1A-2B), with the devices of the present disclosure the heat is detected before the heat reaches the pressure vessel envelope 114 and the respective pressure control devices may activate to vent the fluid from the pressure vessel. In the prior art devices, the envelope may be subjected to the heat source and to subsequent damage before the prior art devices are able to detect the heat source and vent the pressure vessel. Thus, the pressure control devices of the present disclosure may provide better protection for thermal damage to a pressure vessel caused by heat sources (both point and engulfing heat sources).

In some examples, a pressure control device disclosed herein may include an intermediate element between the heat sensor and the internal fluid control portions of the valve. An intermediate element may be any structure or device that detects, or is influenced by, a physical or electrical change in a sensing element resulting from heating of the sensing element, where the intermediate element triggers the opening of the valve responsive to the change in the sensing element. In such embodiments, a heat sensor may have an effect on the intermediate component based on the detection of a heat source 102. Rather than opening the valve directly, as in the example of the pressure control devices 300 and/or 400, embodiments of pressure control devices with an intermediate element may use the effect of the heat sensor on the intermediate element to trigger an overall response of the pressure control device. Another feature of the pressure control device 900 is that once triggered by a heat sensor such that the pressure control device 900 opens, the pressure control device 900 may be configured not to automatically reset, but rather require a manual reset, such as by service personnel. This anti-reset feature has many benefits. For example, typically when a pressure vessel is subjected to a heat source 102 of sufficient intensity to cause the contents of the vessel to be vented, it is desirable to inspect the pressure vessel 104 for damage before re-pressurizing the vessel. Additionally, when a valve is allowed to automatically reset, a situation can occur where heat and pressure build up in the vessel to the point that a pressure relief device opens, relieving the pressure to the point where the valve closes again. In such situations, the pressure relief device may periodically open and close relieving pressure, instead of safely venting substantially all of the contents of the vessel. Such behavior can lead to a situation where first responders may believe a vessel is empty, when it in fact is not, creating a safety hazard. The heat sensor used with a pressure control device 900 may include a heat collector, or may be used without a heat collector.

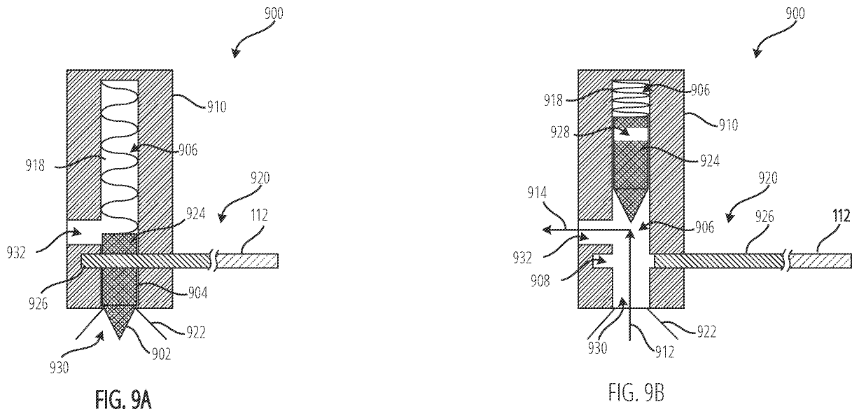

With reference to FIG. 9A and FIG. 9B, an example of an anti-reset pressure control device 900 with a trigger mechanism 920 is disclosed. The pressure control device 900 may be actuated by a heat sensor, as described herein. In particular, the pressure control device 900 may be suitable for use with a heat sensor 302, heat sensor 404, or the like. The pressure control device 900 includes a valve 916 suitable to control the flow of fluid from a vessel. The valve 916 is formed of a main body 910. The main body 910 includes a fluid inlet 912 and a fluid outlet 914 through which a fluid flows in and out of the main body 910, respectively, when the valve 916 is in the open configuration. The fluid inlet 912 is in fluid communication with an inlet chamber 930. The fluid outlet 914 is in fluid communication with an outlet chamber 932. The main body 910 includes a channel 906 formed therein. In some embodiments, the channel 906 is formed of an aperture or other internal compartment of the main body 910 that enables fluid communication between the fluid inlet 912, the inlet chamber 930, the channel 906, the outlet chamber 932, and the fluid outlet 914.

A poppet 924 is disposed in the channel 906. In some embodiments, a biasing element 918 biases the poppet 924 toward the inlet chamber 930. In some embodiments, the 918 is optional and is not included. The poppet 924 has a body 904 and a seat 902. The seat 902 is adapted to seal with the seat 922 of the inlet chamber 930 such that the poppet 924 prevents the flow of a fluid between the fluid inlet 912 and the fluid outlet 914. For example, when the poppet 924 is in the position shown in FIG. 9A (i.e., the closed position), the poppet 924 prevents fluid flow between the inlet chamber 930 and the outlet chamber 932.

The poppet 924 may be secured in the closed position by a trigger mechanism 920. The trigger mechanism 920 is adapted to react to the detection of a heat source 102 by the heat sensor and, in response, open the pressure control device 900. In the example shown in FIG. 9A and FIG. 9B, the trigger mechanism 920 includes a lock structure 926 received in a receptacle 928 formed in the body 904 of the poppet 924. In the example shown, the receptacle 928 is a through hole through the body 904 of the poppet 924. In other examples, the receptacle 928 may be a blind hole or depression that extends only partly into the body 904 of the poppet 924. In other examples, still, the receptacle 928 may be a surface feature of the body 904 of the poppet 924. In still further examples, the lock structure 926 may be a spherical structure and the receptacle 928 a correspondingly shaped detent, hole, or depression formed in the body 904 of the poppet 924. The receptacle 928 is suitable to receive a portion of the lock structure 926 to secure the poppet 924 in the closed position. In the example shown, the receptacle 928 is substantially aligned with a receptacle 908 formed in the main body 910 of the valve. For example, the receptacle 908 may extend through a portion of the 910 on one side of the channel 906 and partially through main body 910 on a second side of the channel 906. In this example, the lock structure 926 extends through the receptacle 928 in the poppet 924 and into the receptacle 908 in the main body 910 when the poppet 924 is in the closed position. For example, the lock structure 926 may be a shaft, key, ball, or other structure that secures the poppet 924 in the closed position.

The lock structure 926 may be joined to the heat sensor, such as to a sensing element 112 or a link 406, or similar structure such that when the heat sensor detects a heat source 102, the sensing element 112 element may generates a varied output (e.g., a physical or electrical change) in response to the application of heat (e.g., shrink, retract, or otherwise apply a force to the lock structure 926) to cause the lock structure 926 to withdraw, at least partially, from the receptacle 908 and/or the receptacle 928. See, e.g., FIG. 9B where the sensing element 112 has withdrawn the lock structure 926 partially from the receptacle 908 and completely from the receptacle 928 such that the pressure differential between the fluid inlet 912 and the fluid outlet 914 is sufficient to cause the poppet 924 to move from the closed position (e.g., FIG. 9A) to the open position (e.g., FIG. 9B). If a biasing element 918 is used, the pressure differential may be sufficient to overcome the bias from the biasing element 918 as well. Even if the sensing element 112 were to allow the lock structure 926 to move back to the position shown in FIG. 9A, the lock structure 926 may be shaped or sized to prevent it from blocking the flow of the fluid between the fluid inlet 912 and the fluid outlet. In one example, the pressure control device 900 includes a valve 916 including a body having a fluid inlet and a fluid outlet formed therein and in fluid communication with one another, a poppet 924 disposed between and operative to selectively prevent a flow of fluid between the fluid inlet 912 and the fluid outlet 914, and an intermediate element 926 selectively engaged with the poppet 924 to selectively fix the poppet 924 in a closed position; and a sensing element 112 coupled to the intermediate element 926 and operative to receive heat from a heat source 102. When the sensing element 112 receives the heat, the sensing element 112 disengages the intermediate element 926 from the poppet 924 to enable the poppet 924 to move from the closed position to an open position and selectively allow the flow of fluid between the fluid inlet 912 and the fluid outlet 914.

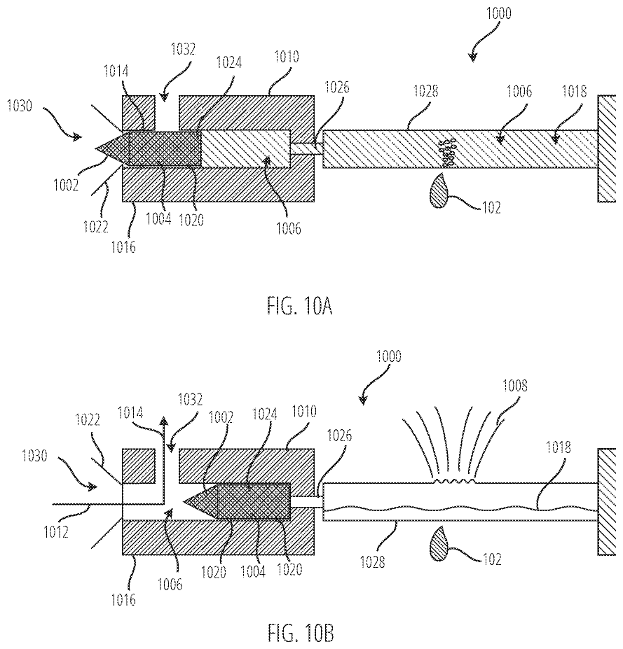

FIG. 10A and FIG. 10B show an example of an embodiment of a pressure control device 1000. Similar to the pressure control device 900, the pressure control device 1000 includes a valve 1016 with a main body 1010. The valve 1016 is suitable to control the flow of fluid from a pressure vessel 104. The main body 1010 includes a fluid inlet 1012 and a fluid outlet 1014 through which a fluid flows in and out of the main body 1010, respectively, when the valve 1016 is in the open configuration. The fluid inlet 1012 is in fluid communication with an inlet chamber 1030. The fluid outlet 1014 is in fluid communication with an outlet chamber 1032. The main body 1010 includes a channel 1006 formed therein. In some embodiments, the channel 1006 is formed of an aperture or other internal compartment of the main body 1010 that enables fluid communication between the fluid inlet 1012, the inlet chamber 1030, the channel 1006, the outlet chamber 1032, and the fluid outlet 1014.

The channel 1006 is adapted to receive a poppet 1024. The poppet 1024 includes a seat 1002 and a body 1004. The seat 1002 is adapted to seal against a seat 1022 of the main body 1010 defining a closed position of the valve 1016. The channel 1006 may contain a working fluid 1018. The poppet 1024 may have one or more seals that contain the working fluid 1018 in the channel 1006 or prevent the working fluid 1018 from flowing past the seal 1020. For example, one or more seals 1020 may extend around a circumference of the body 1004 and may contact an inner wall of the channel 1006 to prevent the leakage of the working fluid 1018 past the seals 1020. The seals 1020 may be o-rings, lip seals, gaskets, or other suitable structure to prevent the leakage of the working fluid 1018 from the channel 1006. The seals 1020 may also help position the poppet 1024 with respect to the seat 1022 (e.g., may center the poppet 1024 in the channel 1006 to align the poppet seat 1002 with the main body seat 1022).

The working fluid 1018 may be pressurized so as to hold the poppet 1024 in a closed position, preventing the flow of fluid from the fluid inlet 1012 to the 1014 and out of a pressure vessel 104. The main body 1010 may have formed therein a conduit 1026. The conduit 1026 may be in fluid communication with the channel 1006. The conduit 1026 may also be in fluid communication with a sensing element 1028. The sensing element 1028 may be used with or without a heat collector. The conduit 1026 and the sensing element 1028 may also contain a portion of the working fluid 1018, such that a portion of the channel 1006, the conduit 1026, and the sensing element 1028 may be in fluid communication with one another.

When exposed to a heat source 102, the working fluid 1018 may experience a phase change (e.g., boil) and/or expand, causing the sensing element 1028 to form a leak or rupture 1008. The phase change of the working fluid 1018 (e.g., boiling) and/or the rupture 1008 of the sensing element 1028 may allow the pressure differential between the fluid inlet 1012 and the fluid outlet 1014 to push the poppet 1024 from a closed position (e.g., as shown in FIG. 10A) to an open position (e.g., as shown in FIG. 10B). In the example where the working fluid 1018 boils, the gaseous phase of the working fluid 1018 may be more compressible than the liquid phase, allowing the differential pressure between the fluid inlet 1012 and the fluid outlet 1014 to compress the gaseous phase as the poppet 1024 moves from the closed to the open position (e.g., from the position shown for example in FIG. 10A to that shown in FIG. 10B. In the example, where the sensing element 1028 ruptures, the working fluid 1018 may simply boil or leak out of the sensing element 1028, again allowing the poppet 1024 to open. As with the pressure control device 900, once triggered by a heat sensor the pressure control device 1000 such that the pressure control device 1000 opens, the pressure control device 1000 does not automatically reset and can be reset manually, such as by service personnel.

Although shown as a cylinder in FIG. 10A/B for simplicity, the sensing element 1028 may be any shape suitable to detect a heat source 102 and protect a pressure vessel 104 therefrom. For example, the sensing element 1028 may be a chamber or a thin (relative to the thickness of the pressure vessel wall) annular jacket that at least partially, substantially, or completely surrounds the pressure vessel 104. The sensing element 1028 may be located close to the pressure vessel 104 or may be located remotely.

The material forming the sensing element 1028 may be any material that weakens to the point of forming a rupture 1008 when exposed to a heat source 102 and yet is strong enough to contain a working fluid 1018 at a sufficiently high pressure to keep the poppet 1024 in the closed position in the absence of a heat source 102. For example, the sensing element 1028 may be formed of a low melting temperature metal (e.g., tin, lead, etc.), glass, or a polymer such a polyethylene, polypropylene, or the like.

The working fluid may be any fluid that is a liquid at normal environmental conditions, and yet readily boils when exposed to a heat source 102. For example, in some climates (e.g., with mild winters) the working fluid 1018 may be water. In some applications, the working fluid 1018 may be an oil, glycerin, wax, various alcohols (e.g., ethylene or propylene glycol, ethanol, isopropanol), refrigerants, combinations thereof, etc.

In one example, the pressure control device 1000 includes a valve having: a body having a fluid inlet and a fluid outlet formed therein and in fluid communication with one another, a channel formed in the body between the fluid inlet and the fluid outlet, a poppet disposed in the channel between and operative to selectively prevent a flow of fluid between the fluid inlet and the fluid outlet, and a first portion of a working fluid received in a portion of the channel and operative to selectively fix the poppet in a closed position; and a sensing element that contains a second portion of the working fluid. The first portion of the working fluid is in fluidic communication with the second portion of the working fluid, when the sensing element receives heat from a heat source, the second portion of the working fluid experiences a phase change such that the poppet moves from a closed position to an open position and selectively allows the flow of the fluid between the fluid inlet and the fluid outlet.

The pressure control device 1000 has many benefits. For example, by the use of a working fluid in the sensing element 1028 in fluid communication with the channel 1006, a great degree of packaging flexibility for the sensing element 1028 may be achieved. For example, as mentioned above, the sensing element 1028 may take the form of a jacket around at least a portion of a pressure vessel. In other examples, the sensing element 1028 may be one or more channels or conduits formed in the envelope 110 of the pressure vessel 104 itself. Alternately, the sensing element 1028 may be located wither close to the pressure vessel 104 or far from the pressure vessel 104 (e.g., near a potential source of fire). As with the pressure control device 900, the anti-reset features of the pressure control device 1000 have similar safety benefits as the pressure control device 900 discussed herein.

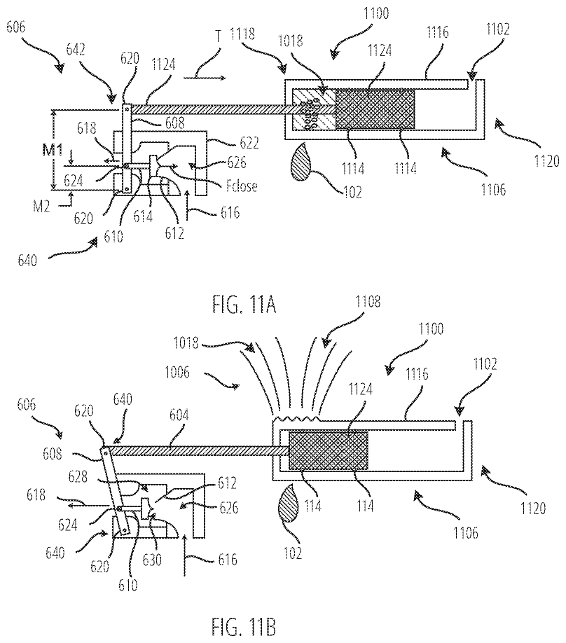

With reference to FIG. 11A and FIG. 11B, an example of a pressure control device 1100 is shown. The pressure control device 1100 includes a valve 606 as described with respect to the pressure control device 600. The pressure control device 1100 differs from the pressure control device 600 in the use of a sensing element 1106 that uses a working fluid 1018 to detect a heat source 102. The sensing element 1106 includes a cylinder 1116 that slidingly receives a piston 1124. The cylinder 1116 may contain the working fluid 1018 at one end portion (e.g., a closed portion 1118) thereof. The cylinder 1116 may have an open portion 1120 opposite the closed portion 1118. The open portion 1120 may be in fluid communication with the environment via a vent 1102. The piston 1124 may be disposed between the closed portion 1118 and the open portion 1120. The piston 1124 may define boundaries of either or both of the closed portion 1118 or the open portion 1120. For example, as the piston 1124 moves toward the open portion 1120, the open portion 1120 may shrink and the closed portion may grow, and vice versa. The piston 1124 may include one or more seals 1114 that reduce or prevent the flow of the working fluid 1018 past the piston 1124 between the closed portion and the open portion 1120. A link 1104 may connect the piston 1124 to the arm 608 of the valve 606. The link 1104 may be a rigid link or rod that transmits sliding motion of the piston 1124 in the cylinder 1116 to the arm 608 and thus moves the valve 606 between the open and closed positions as previously described.

The cylinder 1116 may be formed of the same or similar materials as the sensing element 1028, e.g., materials that melt or otherwise form a ruptures 1108 when exposed to a heat source 102. In operation, the closed portion 1118 of the cylinder 1116 may be initially filled with the working fluid 1018. The working fluid 1018 may be pressurized to a level suitable to hold the valve 606 in the closed position. When exposed to a heat source 102, the sensing element 1106 may initially tighten a closure of the valve 606 when exposed to a heat source 102, as the working fluid 1018 expands and/or boils and the volume of the working fluid 1018 in the closed portion 1118 increases, increasing tension in the link 1104 as the piston 1124 moves away from the closed portion 1118 of the cylinder 1116 toward the open portion 1120 of the cylinder 1116. Upon further exposure to the heat source 102, the cylinder 1116 may form a rupture 1108 allowing the working fluid 1018 to escape from the closed portion 1118. The piston 1124 may then slide along the cylinder 1116 toward the closed portion 1118, releasing tension on the link 1104 and allowing the valve 606 to open. Advantages of the pressure control device 1100 include an anti-reset feature as discusses with respect to the pressure control device 900 and the pressure control device 1000.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A pressure control device comprising:
a valve including a fluid inlet and a fluid outlet, wherein the fluid inlet is in fluid communication with an internal compartment of a pressure vessel and is in selective fluid communication with the fluid outlet;
a sensing element operative to detect heat from a heat source, wherein when the sensing element detects the heat, the sensing element actuates the valve to establish the selective fluid communication between the fluid inlet and the fluid outlet; and
a heat collector adapted to at least partially surround an envelope of the pressure vessel and operative to receive the heat from the heat source, wherein the sensing element is in thermal communication with the heat collector.

2. (canceled)

3. The pressure control device of claim 3, wherein the heat collector includes a heat conduit operative to direct the heat from the heat source to the sensing element, wherein the heat conduit contains a heat transfer fluid that vaporizes to form a vapor responsive to exposure to the heat source, wherein the vapor carries the heat to an end of the heat conduit proximate to the sensing element.

4. (canceled)

5. The pressure control device of claim 1, wherein a dimension of the sensing element decreases responsive to exposure to the heat source.

6. The pressure control device of claim 1, wherein the valve comprises,
a body forming an inlet chamber in fluid communication with the fluid inlet, and
an outlet chamber in fluid communication with the fluid outlet:
a seat disposed between the inlet chamber and the outlet chamber including an aperture in fluid communication with the inlet chamber and the outlet chamber; and
a poppet operative to selectively close the aperture to sever the fluid communication between the inlet chamber and the outlet chamber, wherein the poppet is operatively coupled to the sensing element.

7.-9. (canceled)

10. The pressure control device of claim 5, wherein the sensing element includes a shape memory alloy.

11. The pressure control device of claim 1, wherein the sensing element comprises two or more sensing elements coupled to a connector.

12. (canceled)

13. The pressure control device of claim 1, wherein a dimension of the sensing element increases responsive to exposure to the heat source.

14.-15. (canceled)

16. The pressure control device of claim 13, wherein the sensing element has a positive coefficient of thermal expansion.

17. The pressure control device of claim 1, wherein the sensing element generates an electric current responsive to exposure to the heat source, and the electric current is operative to actuate the valve.

18. The pressure control device of claim 17, wherein the sensing element comprises two or more dissimilar electrical conductors in electrical communication with one another to form a thermo-voltaic junction.

19. The pressure control device of claim 1, wherein the sensing element is breakable responsive to exposure to the heat source.

20. The pressure control device of claim 1, wherein the sensing element is burnable responsive to exposure to the heat source.

21.-27. (canceled)

28. The pressure control device of claim 1, wherein at least a portion of one of the sensing element or the heat collector is integrally formed with the envelope of the pressure vessel.

29. The pressure control device of claim 28, wherein the pressure vessel envelope includes a composite material and at least one of the sensing element or the heat collector is woven with the composite material.

30. The pressure control device of claim 1, wherein the heat collector forms at least a portion of an outer layer of the envelope.

31. A pressure control device comprising:
a valve including:
a body having a fluid inlet and a fluid outlet formed therein and in fluid communication with one another,
a poppet disposed between and operative to selectively prevent a flow of fluid between the fluid inlet and the fluid outlet, and
an intermediate element selectively engaged with the poppet to selectively fix the poppet in a closed position;
a sensing element coupled to the intermediate element and operative to detect heat from a heat source, wherein when the sensing element detects the heat, the sensing element disengages the intermediate element from the poppet to enable the poppet to move from the closed position to an open position and selectively allow the flow of fluid between the fluid inlet and the fluid outlet; and
a heat collector adapted to at least partially surround an envelope of a pressure vessel and operative to receive heat from the heat source, wherein the sensing element is in thermal communication with the heat collector.

32.-42. (canceled)

43. A system for detecting a heat source proximate to a pressure vessel comprising:
a heat collector adapted to at least partially surround an envelope of the pressure vessel and to receive heat from the heat source:
a sensing element operative to:
receive the heat from the heat collector, and
upon receiving the heat from the heat collector cause a valve in fluid communication with the internal compartment of the pressure vessel to open, thereby venting a gas contained within the internal compartment.

44. The system of claim 43, wherein the sensing element is adapted to substantially surround the envelope of the pressure vessel.

45. The system of claim 1, wherein the sensing element is adapted to substantially surround the envelope of the pressure vessel.

46. The system of claim 31, wherein the sensing element is adapted to substantially surround the envelope of the pressure vessel.
